(19) United States
(12) Patent Application Publication
(10) Pub. No.: US 2008/0079914 A1
(43) Pub. Date: Apr. 3, 2008

(54) Light projector

(75) Inventor: Perttu Kivela, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/542,730

(22) Filed: Oct. 2, 2006

(51) Int. Cl. G03B 21/26

(52) U.S. Cl. 353/94

(57) ABSTRACT

A light projector comprising a plurality of light sources, a lens assembly for directing light from the light sources and a light valve for selectively modulating the light from the light sources to provide an image to be projected, wherein the plurality of light sources are arranged to be spatially interchangeable about a light transmitting position for selectively directing light from each light source in sequence through the lens assembly and for modulation by the light valve.

The present invention relates to apparatus and methods for projecting light, for example relating to projection of static or moving images.

### BACKGROUND

Image display technology is currently advancing so that successive generations of image projectors are able to produce more faithful, brighter and sharper images, and at a reduced cost compared with older technology.

In essence, a light projector for projecting images requires a means for generating light and a means for modulating the light to allow for projection of an image to be viewed. There exist many different means for both transmitting and modulating light for such projectors. Means for generating light may, for example, incorporate incandescent, fluorescent, phosphorescent or semiconductor light sources. Means for modulating light may, for example, incorporate various lenses, reflectors, prisms and light valves in various combinations.

Many different types of light valves are possible, as for example described in “From cathode rays to digital micromirrors: A history of electronic projection display technology” by Larry J. Hornbeck (TI Technical Journal, July-September 1998, pp. 7-46), the contents of which are incorporated by reference herein. Modern light valves are typically based on Liquid Crystal Display (LCD) technology or on Digital Light Processor (DLP) technology comprising one or more Digital Micromirror Devices (DMDs) (‘DLP’, ‘Digital Light Processor’, ‘DMD’ and ‘Digital Micromirror Device’ are trademarks of Texas Instruments).

A conventional light projector based on DLP technology may comprise a white light source, the constituent colors of which are separated by means of a color disc, as described for example by Hornbeck. The color disc comprises regions of differing color filtering characteristics, such that light passing through it is filtered to a particular color depending on the rotational position of the color disc.

Typically, a color disc will have red, green and blue filter portions. The output of the light source is temporally modulated on rotation of the color disc such that red, green and blue light is sequentially directed on to a light valve. Synchronisation of the light valve with the incident light color allows individual color control of the composite image projected by modulating each color separately in sequence. When viewing the image produced, the human eye is unable to react to the rapid changes in color, and so perceives a mixture of colors in the same way that a rapid succession of images provides the impression of movement.

Alternative means of generating light may comprise a white light source, which is split into red, green and blue components. Each component may then be modulated separately by separate light valves, and the modulated color outputs combined before being projected. Such a system is, for example, disclosed in US 2005/0057729 A1. Such systems require many lens and reflector components.

Other light projectors may comprise a separate light source for each color component. One example is disclosed in US 2006/0164600 A1, which describes LED panels of blue, green and red light outputs, each light output being directed on to a DMD light valve. Synchronisation of the light outputs from each panel with switching of pixels on the DMD enables a temporally modulated light output similar to that of color disc-based projectors. Similar LED-based systems are also disclosed in US 2005/0213055 A1 and US 2005/0219478 A1.

Certain problems associated with previous light projector solutions include those of being bulky, complex and expensive due to the number of optical components required, or being wasteful of light due to filtering out of the bulk of the wavelengths transmitted by the light source, resulting in excess heat being generated.

The listing or discussion of a prior-published document in this specification should not necessarily be taken as an acknowledgement that the document is part of the state of the art or is common general knowledge.

### SUMMARY

According to the invention, there is provided a light projector comprising: a plurality of light sources; a lens assembly; and a light valve, wherein the plurality of light sources are arranged to be spatially interchangeable for selectively directing light from each light source in sequence through the lens assembly and for modulation by the light valve, the light valve being arranged to selectively modulate received light to form an image to be projected.

The light sources may be light emitting diodes.

The plurality of light sources may comprise a red light source, a green light source and a blue light source.

The light sources may be rotatably interchangeable about an axis of rotation.

The light sources may be adapted to emit light in a direction parallel to, or orthogonal to, the axis of rotation.

The light sources may be translatably interchangeable in order to position each light source in sequence to direct light through the lens assembly and for modulation by the light valve.

The light sources may be reciprocally translatable along the axis. The axis may be linear.

The light sources may be translatable along a first axis and a second axis. The first and second axes may be substantially orthogonal relative to one another.

The lens assembly may comprise: a first lens for receiving light from the light sources and directing the light towards the light valve; and a second lens for receiving modulated light from the light valve and for projecting an image formed from the modulated light. The lens assembly may further comprise a reflector for directing light from the first lens towards the light valve. The reflector may also be adapted to direct modulated light from the light valve towards the second lens.

The light projector may further comprise a light integrator for directing light from the light sources towards the first lens.

The light sources may be arranged to be sequentially located about a light transmitting position for transmission of light through the lens assembly, the light transmitting position optionally being located at or proximate a focal point of the first lens.

The light projector may further comprise a controller for controlling a plurality of spatial configurations of the light sources. The controller may be adapted to control a temporally modulated light output from each of the light sources, the light output being synchronised with the plurality of spatial configurations.

The controller may be arranged to increase power to each light source when located proximate a light transmitting position and to reduce power to each light source when located away from the light transmitting position.

Any circuitry of or associated with the light projector may include one or more processors, memories and bus lines. One or more of the circuitries may share circuitry elements.

The present invention includes one or more aspects, embodiments and/or features of said aspects and/or embodiments in isolation and/or in various combinations whether or not specifically stated (including claimed) in that combination or in isolation.

### BRIEF DESCRIPTION OF THE DRAWINGS

A description is now given, by way of example only, with reference to the accompanying drawings, in which:

FIG. 1a illustrates a schematic 3-dimensional view of an exemplary light projector in a first configuration;

FIG. 1b illustrates a schematic 3-dimensional view of an exemplary light projector in a second configuration;

FIG. 1c illustrates a schematic 3-dimensional view of an exemplary light projector in a third configuration

FIG. 2 illustrates a schematic 3-dimensional view of an alternative exemplary light projector;

FIG. 3 illustrates a schematic 3-dimensional view of an alternative exemplary light projector;

FIG. 4 illustrates a schematic 3-dimensional view of an alternative exemplary light projector; and

FIG. 5 illustrates a schematic flow diagram of the operation of an exemplary light projector.

FIG. 6 illustrates a schematic diagram of an exemplary light projector controller arrangement.

### DETAILED DESCRIPTION

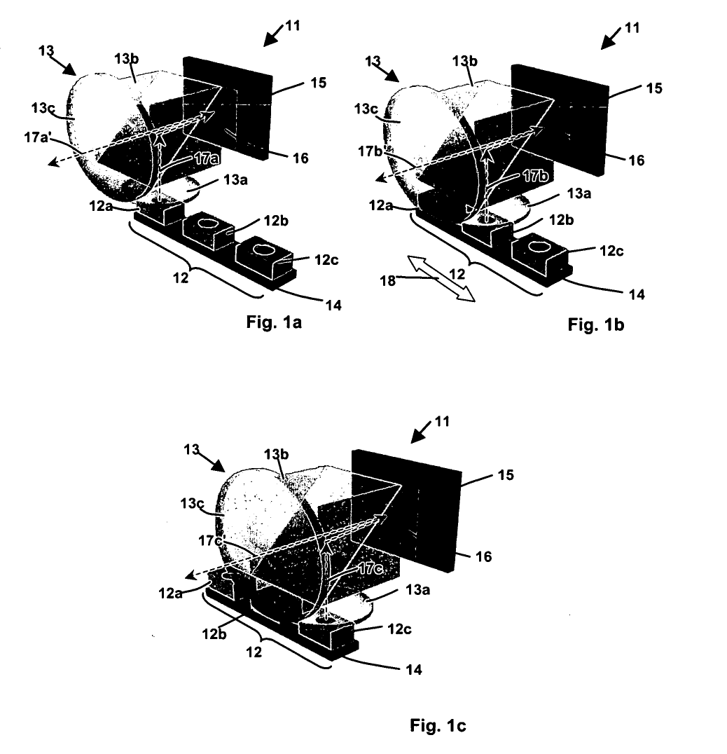

Illustrated in FIGS. 1a to 1c is an exemplary light projector 11. The light projector 11 comprises a plurality of light sources 12, which in this example are a blue light source 12a, a green light source 12b and a red light source 12c. The light sources 12 may be light emitting diodes (LEDs) or any other suitable means for generating light over different chosen ranges of the visible spectrum. The light sources 12 may be mounted on a common base 14 to maintain a chosen spatial arrangement of the light sources 12.

The light sources 12 are arranged to be spatially interchangeable about a light transmitting position. In FIGS. 1a-c, three different spatial configurations are shown, in which each light source is respectively shown at a light transmitting position proximate a lens assembly 13.

For illustrative purposes, the light sources 12 are indicated as a blue light source 12a, a green light source 12b and a red light source 12c, although any suitable number of light sources 12 may be used with the invention, which is not limited to the three light sources illustrated.

The blue light source 12a is shown in FIG. 1a at a light transmitting position proximate the lens assembly 13. The lens assembly 13 in this example comprises a first lens 13a for receiving light from the light source 12a. Generally, the first lens 13a will perform the function of focussing and/or collimating light from the light source 12a. A light ray 17a is shown extending from the light source 12a at the light transmitting position, passing through the first lens 13a and into a prism or reflector 13b. The light ray 17a is internally reflected by the prism 13b to become incident upon a light valve 15. In the example shown, the light valve 15 comprises a micromirror array 16, such as a Digital Micromirror Device (DMD). The micromirror array reflects selected portions of the light incident upon it back through the prism 13b. Portions not selected are reflected at a different angle, and are consequently not projected.

A selected light ray 17a′ is shown in FIG. 1a, after having been selected by the micromirror array 16. The light ray 17a′ passes through the prism and is not reflected due to being incident upon an internal surface of the prism 13b at an angle less than the critical angle above which total internal reflection occurs. The light ray 17a′ then passes through a second lens 13c of the lens assembly 13 and is projected. The second lens 13c serves as a projection lens, and focuses the light rays incident upon it into a required form for projection.

The light projector 11 is shown in FIG. 1b with the green light source 12b at the light transmission position, the light sources 12 having been translated from the configuration shown in FIG. 1a. The arrow 18 indicates the direction in which the light sources 12 can be made to translate from the position shown in FIG. 1b. A light ray 17b from the green light source 12b at the light transmitting position passes through the first lens 13a, is reflected by the prism 13b, selected by the micromirror array 16 and a reflected ray 17b′ passes back through the prism 13b and through the second lens 13c to be projected.

Shown in FIG. 1c is the light projector 11 with the light sources 12 in a third configuration, in which the red light source 12c is located at the light transmitting position. As before, a light ray 17c passes through the first lens 13a, is reflected by the prism 13b, selected by the micromirror array 16 and a reflected ray 17c′ passes back through the prism 13b and through the second lens 13c to be projected.

Although the above description illustrates the light sources 12 in three discrete positions, it is to be understood that a continuous movement of the light sources 12 between the configurations shown in FIGS. 1a and 1c is also envisaged, where each light source 12a-c moves into and out of the light transmitting position as the light sources are translated between the different spatial configurations relative to the lens assembly 13. Translation of the light sources 12 may comprise a reciprocating sliding action, where the light sources are repeatedly moved back and forth between the positions shown in FIGS. 1a and 1c.

If the transitions between the different spatial configurations of FIGS. 1a-c are made sufficiently quickly (i.e. many times per second), and the light output from each light source 12a-c is synchronised with the light valve 15, an image projected can appear to a human viewer to be in full color, due to persistence of vision in a human eye of each individual color component. The overall brightness and color balance of a projected image, as viewed through a human eye, can be modified by altering the absolute and relative durations respectively of light outputs from each light source 12a-c over each cycle of transitions. For example, by reducing the time during which each light source is transmitting light, the overall brightness of a projected image can be reduced. Alternatively, the light transmission duration of a particular light source may be extended or shortened relative to the other light sources in order to alter the color balance of the projected image.

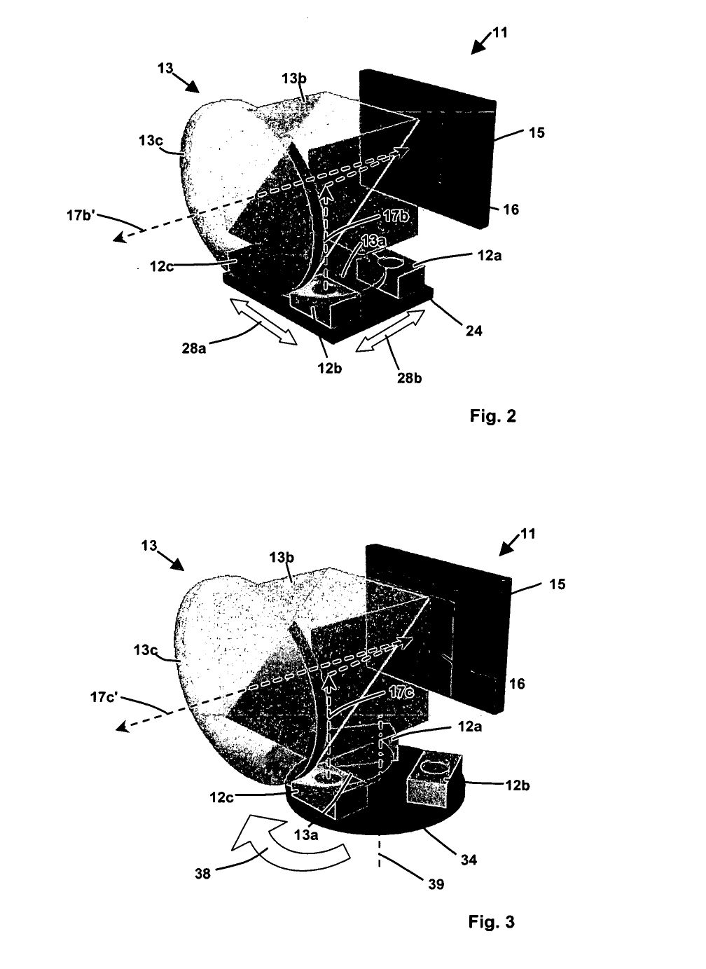

Shown in FIG. 2 is an alternative exemplary light projector, in which the light sources 12a-c are instead arranged on a base 24 in a two-dimensional array. The light sources 12 are arranged to be translatable along a first axis, the direction of which is indicated by the arrow 28a, to interchange light sources 12b and 12c, and along a second axis, the direction of which is indicated by arrow 28b, to interchange light sources 12a and 12b. Other features of the light projector, i.e. the lens assembly 13 and the light valve 15 may be the same as in the previous example of FIGS. 1a-c.

The light sources 12a-c of FIG. 2 may be arranged to be translatable such that each light source is located at the light transmitting position in sequence. The axes of translation may be orthogonal to one another, although other angular arrangements are also possible. For example, a triangular arrangement of the light sources 12a-c may be configured to be translatable in two axes at an angle greater than or less than 90° to one another, or in three axes oriented at 60° to one another, or in a configuration such that the angles between each pair of axes add up to 180°.

Shown in FIG. 3 is a further alternative arrangement for a light projector 11. In this arrangement, the light sources 12a-c are arranged to be rotatably interchangeable about an axis of rotation 39. The light sources 12a-c may be mounted on a base 34 that is rotatable and, for example, powered by a motor. Each light source 12a-c may be quickly interchangeable about the light transmission position, at which the red light source 12c is shown as being located. In this arrangement the light sources 12a-c are adapted to emit light 17c in a direction substantially parallel to the axis of rotation 39.

The operation of the light projector 11 of FIG. 3 may otherwise be similar to the operation described above.

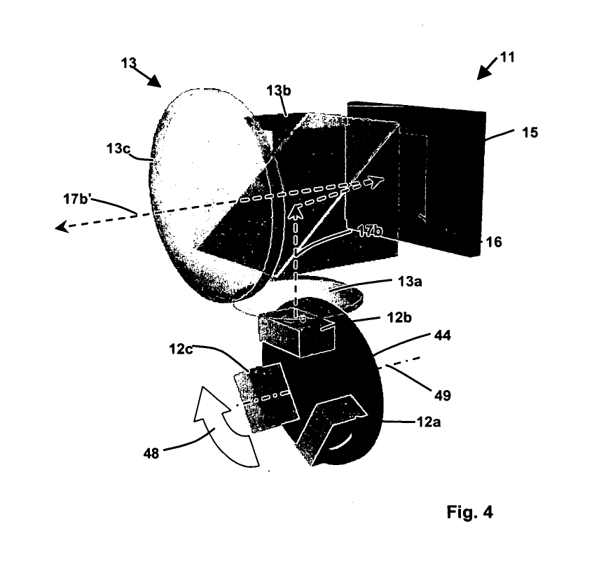

Shown in FIG. 4 is a yet further alternative arrangement for a light projector 11. In this arrangement, the light sources 12a-c are arranged to be rotatable about an axis 49, the axis 49 being substantially orthogonal to a direction in which the light sources are adapted to transmit light 17b.

It is to be understood that the axis of rotation 39, 49 may be varied between the two limits shown in FIGS. 3 and 4 without departing from the scope of certain embodiments of the invention, provided that the light sources 12a-c are adapted to transmit light towards the lens assembly for modulation by the light valve and subsequent projection.

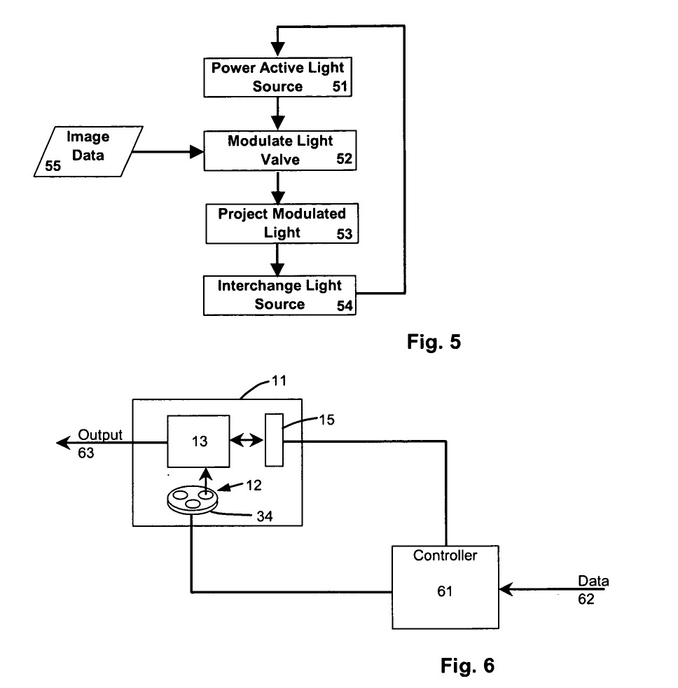

In operation, a exemplary light projector may follow the method illustrated schematically in FIG. 5. With the light sources in any given spatial configuration, the ‘active’ light source, i.e. the light source that is proximate or most proximate the light transmitting position, is powered (51). The light valve 15 is modulated 52 according to image data 55 for the relevant color of light and according to which color of light is being transmitted from the active light source.

The light thereby modulated by the light valve 15 is projected 53. The light sources are then interchanged 54, replacing the active light source with the next light source in sequence.

The above method may be enacted as a sequence of operations, or may be a continuous process. For example, the interchanging of light sources may be continuous rather than discrete. Powering of an active light source may be dependent on the position of a particular light source in relation to the light transmitting position. A light source may be powered up, i.e. taken from a low power state (which may be zero) to a higher power state, as the light source approaches the light transmission position, and then powered down, i.e. taken from the high power state to a lower power state (which may be zero), as the light source moves away from the light transmission position. Thus, in certain embodiments, the light sources may be transmitting light when not at the light transmitting position.

The light projector of the invention may comprise further features without departing from the scope of the invention as defined in the appended claims. For example, a light integrator may be positioned between the light sources 12 and the lens assembly 3, in order to spread the light emitted by the light sources to a suitable shape.

A light projector of the invention may advantageously be made sufficiently compact to be portable, and may further be sufficiently compact to be hand-portable. For example, a hand-portable electronic device such as a mobile telephone may incorporate a light projector of the invention. Advantages such as low power consumption and small size would in such an application be useful.

Since the light projector of the invention may be configured such that a single color light is activated only when required, i.e. when a relevant color light source 12a-c is in or near the light transmitting position, filtering of other colors may be unnecessary. The energy efficiency of the light sources 12 may thereby be increased. For example, if the light sources comprise LEDs of red, green and blue colors, each color LED will only need to be typically activated for up to a third of the time the light projector is activated.

Shown in FIG. 6 is a schematic diagram of an exemplary arrangement of a light projector 11 and a controller 61 for controlling the operation of the light projector 11. The controller 61, which may comprise a processor, memory and associated circuitry, is arranged to control the spatial configurations of the light sources 12, in this example by controlling rotation of the base 34 on which the light sources 12 are mounted. The rotation is synchronised with signals fed from the controller 61 to the light valve 15, such that each color light output is appropriately modulated by the light valve 15. The controller 61 may be fed data 62 relating to the content of the image or images to be projected by the light projector 11. The controller may optionally convert this data into a form useable by the light valve 15.

The controller 61 may be programmed with a suitable computer program adapted to control operation of the light projector 11.

Light valves 15 suitable for use with the invention may vary according to particular requirements and preferences. The above description and examples are illustrated with the use of micromirror array devices such as DMDs, which are reflective devices and hence require particular lens assembly configurations such as those illustrated. Other light valves may alternatively be suitable for the light projector of the invention without departing from the scope of the appended claims. Various particular examples of light valves are described in the aforementioned publication by Hornbeck.

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A light projector comprising:
a plurality of light sources;
a lens assembly for directing light from the light sources; and
a light valve for selectively modulating the light from the light sources to provide an image to be projected,
wherein the plurality of light sources are arranged to be spatially interchangeable about a light transmitting position for selectively directing light from each light source in sequence through the lens assembly and for modulation by the light valve.

2. The light projector of claim 1 wherein the light sources are light emitting diodes.

3. The light projector of claim 1 wherein the plurality of light sources comprise a red light source, a green light source and a blue light source.

4. The light projector of claim 1 wherein the light sources are arranged to be rotatably interchangeable about an axis of rotation.

5. The light projector of claim 4 wherein the light sources are adapted to emit light in a direction parallel to the axis of rotation.

6. The light projector of claim 4 wherein the light sources are adapted to emit light in a direction orthogonal to the axis of rotation.

7. The light projector of claim 1 wherein the light sources are arranged to be translatably interchangeable in order to position each light source in sequence to direct light through the lens assembly and for modulation by the light valve.

8. The light projector of claim 7 wherein the light sources are arranged to be reciprocally translatable along a translation axis.

9. The light projector of claim 8 wherein the axis is linear.

10. The light projector of claim 7 wherein the light sources are arranged to be translatable along a first axis and a second axis.

11. The light projector of claim 10 wherein the first and second axes are substantially orthogonal to one another.

12. The light projector of claim 1 wherein the lens assembly comprises:
a first lens for receiving light from the light sources and directing the light towards the light valve;
a second lens for receiving modulated light from the light valve and for projecting an image formed from the modulated light.

13. The light projector of claim 12 further comprising a reflector for directing light from the first lens towards the light valve.

14. The light projector of claim 13 wherein the reflector is adapted to direct modulated light from the light valve towards the second lens.

15. The light projector of claim 1 wherein the light sources are adapted to be sequentially located about a light transmitting position for transmission of light through the lens assembly, the light transmitting position being located proximate a focal point of a first lens of the lens assembly, the first lens for receiving light from the light sources and directing the light towards the light valve.

16. The light projector of claim 1 wherein the light sources are adapted to be sequentially located about a light transmitting position for transmission of light through the lens assembly, the light transmitting position being located at a focal point of a first lens, the first lens for receiving light from the light sources and directing the light towards the light valve.

17. The light projector of claim 1 further comprising a controller for controlling a plurality of spatial configurations of the light sources.

18. The light projector of claim 17 wherein the controller is adapted to control a temporally modulated light output from each of the light sources, the light output being synchronised with the plurality of spatial configurations.

19. The light projector of claim 18 wherein the controller is arranged to increase power to each light source when located proximate a light transmitting position and to reduce power to each light source when located away from the light transmitting position.

20. A hand-portable electronic device comprising a light projector, the light projector comprising:
a plurality of light sources;
a lens assembly for directing light from the light sources; and
a light valve for selectively modulating the light from the light sources to provide an image to be projected,
wherein the plurality of light sources are arranged to be spatially interchangeable about a light transmitting position for selectively directing light from each light source in sequence through the lens assembly and for modulation by the light valve.

21. A method of operating a light projector, the method comprising:
powering up one or more of a plurality of light sources proximate a light transmitting position;
modulating light from the light source with a light valve;
projecting the modulated light; and
spatially interchanging the light source with a further one or more of the plurality of light sources about the light transmitting position.

22. The method of claim 21 wherein the method is repeated to project a colour image.

23. The method of claim 21 wherein the light from the light source is directed through a lens assembly.

24. Apparatus comprising:
a plurality of means for generating light;
a means for directing light from the means for generating light; and
a means for selectively modulating the light from the means for generating light to provide an image to be projected,
wherein the plurality of means for generating light are arranged to be spatially interchangeable about a light transmitting position for selectively directing light from each of the means for generating light in sequence through the means for directing light and for modulation by the means for modulating light.

25. A computer program for controlling the light projector of claim 1.

26. A controller comprising the computer program of claim 25.
